(19) United States
(12) Patent Application Publication
(10) Pub. No.: US 2007/0157254 A1
(43) Pub. Date: Jul. 5, 2007

(54) Portable vehicle top multimedia player

(76) Inventor: KaiCheng Huang, Taipei City (TW)

Correspondence Address: BIRCH STEWART KOLASCH & BIRCH, PO BOX 747, FALLS CHURCH, VA, 22040-0747, US

(21) Appl. No.: 11/325,445

(22) Filed: Jan. 5, 2006

(51) Int. Cl. A63F 9/24; H04N 7/18; B60R 7/06

(52) U.S. Cl. 725/75; 224/483; 463/46

(57) ABSTRACT

A portable vehicle top multimedia player aims to be attached to an inner side of a vehicle top for use in the vehicle and detachable for use in a mounting manner. It has a longer and firmer axle hinged on a loading and unloading structure. The loading and unloading structure has a latch hook and a detent member to securely hold and anchor the multimedia player. Thus the multimedia player can be loaded rapidly in a ceiling dock to form a safe and secured coupling. By depressing a release button, the multimedia player can be removed from the ceiling dock and carried to other places for use in the mounting manner.

### FIELD OF THE INVENTION

The present invention relates to a multimedia player and particularly to a portable vehicle top multimedia player that can be used by either attaching to a vehicle top or separately in a detached and mounting manner.

### BACKGROUND OF THE INVENTION

The conventional design for vehicle top multimedia player such as the one disclosed in R.O.C. patent publication No. 501855 is a two-in-one structure that includes a DVD optical disk drive and a ceiling-attached LCD TV coupling together. While it is convenient to use and allows rear seat passengers to select desired video programs, it still has room for improvement. For instance, when the vehicle is driven to a recreational destination and parked, people in the vehicle usually leave the vehicle to do some activities. If the vehicle top multimedia display device can be removed and carried away, it can provide another entertainment. Then there is no need to buy another set of portable or desktop multimedia display device. It can save users a lot of cost. Hence removable vehicle top multimedia player is one of research and development focuses in the industry.

At present the techniques for the removable vehicle top multimedia player are already available on the market. However they still have some common problems remained to be overcome, notably the issues of “convenience for fast loading and unloading” and “passenger safety” have to be included and properly balanced. General speaking, there are many techniques available to achieve the convenience of fast loading and unloading. But to simultaneously take into account of safety and secured installation on the vehicle top for a long period of time is a big challenge. For instance, Applicant has proposed a “Detachable vehicle top multimedia display device” in R.O.C patent No. M281845. It aims to achieve fast loading and unloading. It has a ceiling dock 10 with a release button 14 located thereon to control a latch end 152 of a latch lever 15 to latch on a latch hole 23 formed on a multimedia display device 20. While it can achieve the object of fast loading and unloading, it lacks sufficient safety function. This is because the latch end 152 has to allow the multimedia displaying device 20 to be swiveled thereon, also has to be released therefrom rapidly to make fast loading and unloading of the multimedia displaying device 20 possible. Hence the latch end 152 cannot be extended into the latch hole 23 too much. But in the event that an impact accident occurs to the vehicle, or elastic fatigue takes place after used for a period of time, the latch end 152 cannot return to its original position for anchoring. Then the multimedia display device 20 is probe to escape and drop from the ceiling dock 10. It could injure the passengers in the vehicle. Therefore to provide fast loading and unloading and also achieve safety and secured installation on the vehicle top for a long period of time are the main focuses of the present invention.

### SUMMARY OF THE INVENTION

The primary object of the present invention is to solve the aforesaid disadvantages. The present invention provides a portable vehicle top multimedia player that has a longer axle to be hinged on a loading and unloading structure to provide a firmer and longer durability. The loading and unloading structure has a latch hook and a detent member to securely latch and anchor the multimedia player. Thus the multimedia player can be installed quickly and securely on a ceiling dock. It also can be removed rapidly from the ceiling dock by pushing a release button to allow the multimedia player to be carried to other places for use.

In order to achieve the foregoing object, the portable vehicle top multimedia player of the invention includes:

a ceiling dock fastened to an inner side of a vehicle top. It has a release button, an axle, a coupling member and a holding space. The release button has a push stem. The coupling member has a coupling end;

a loading and unloading structure which includes a upper plate, a detent member, a coupled member, and a lower plate. The lower plate has an aperture and two sides each has a latch hook. The detent member and the driven member are located between the lower plate and the upper plate. The lower plate and the upper plate are fastened to form an axle hole to hinge the axle. The detent member further has a detent portion running through the aperture and an upper sliding member formed thereon. The coupled member has a side rod driven by the push stem and a lower sliding member located below and corresponding to the upper sliding member. Hence the coupled member can be moved leftwards and rightwards by moving of the release button, and the lower sliding member can drive the upper sliding member upwards and downwards to move the detent portion up and down; and

a multimedia player which has two edges on a back side that have respectively a latch trough and a latch boss, a detent trough on the top edge of the back side and a coupling trough on the bottom edge of the back side.

By means of the structure set forth above, the latch hook can latch on the latch boss through the latch trough. The detent portion can run through the aperture to press the detent trough, and the coupling end can latch on the coupling trough. Thereby the multimedia player can be loaded rapidly in the holding space of the ceiling dock and anchored, or be unloaded and removed as desired.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an isometric exploded view of the present invention.

FIG. 2 is another exploded view of the present invention.

FIGS. 3A and 3B are schematic views of the moving relationships of the release button, coupled member and detent member of the present invention.

FIGS. 4A through 4E are schematic views of loading operations for the multimedia player of the present invention.

FIGS. 5A through 5D are schematic views of unloading operations for the multimedia player of the present invention.

FIG. 6 is a schematic rear view of the multimedia player of the present invention after removed.

FIGS. 7A and 7B are schematic views of the multimedia player of the present invention after removed and braced by a bracket.

FIGS. 8A and 8B are schematic views of the multimedia player of the present invention after removed for loading batteries.

FIG. 9 is an isometric perspective view of the multimedia player of the present invention attached to the ceiling dock.

FIG. 10 is an isometric perspective view of the ceiling dock of present invention attached to an ornamental board.

### DETAILED DESCRIPTION OF THE PREFERRED EMBODIMENTS

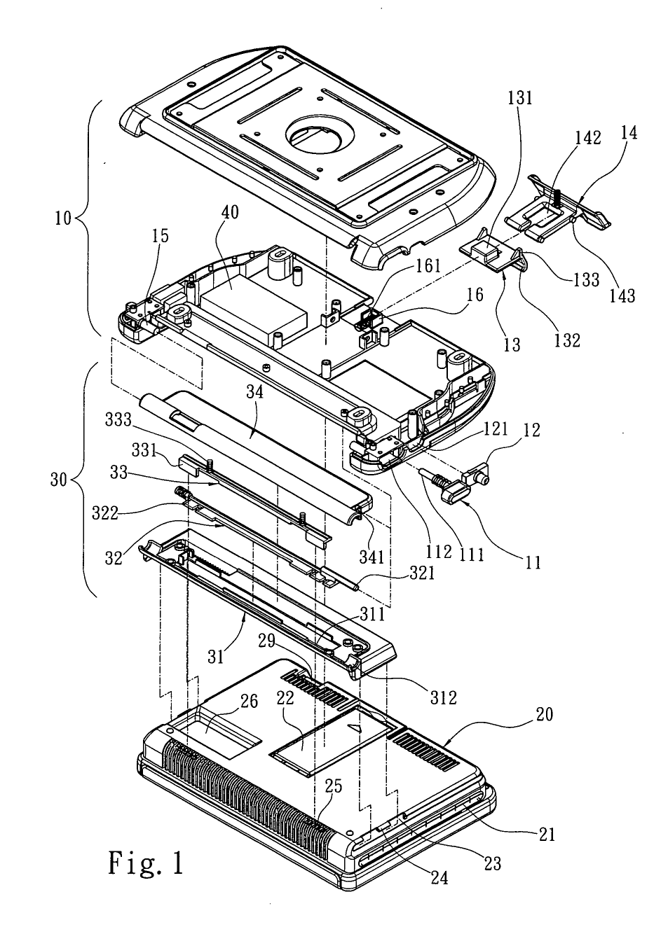

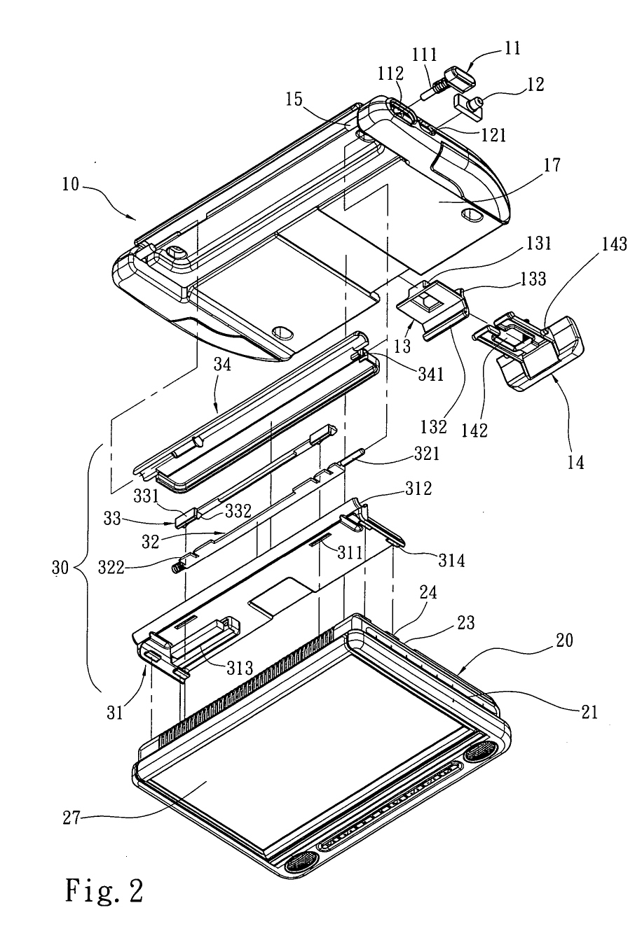

Refer to FIGS. 1 and 2 for the exploded views of the present invention from various angles. The portable vehicle top multimedia player of the invention mainly includes a ceiling dock 10, a loading and unloading structure 30 and a multimedia player 20.

The ceiling dock 10 mainly includes a release button 11, an axle 15, a coupling member 13 and a holding space 17. The release button 11 has a push stem 111. The coupling member 13 has a coupling end 132. The ceiling dock 10 further has a housing trough 16 to hold a spring 161 inside. The coupling member 13 has a jutting trough 131 and an inclined lump 133. The jutting trough 131 aims to cover the housing trough 16 and has one end in contact with the spring 161. The ceiling dock 10 also has a hand-push member 14 which has an opening 142 running through by the jutting trough 131 and a ramming end 143 pressing the inclined lump 133. The ceiling dock 10 further has a cavity 112 to confine the moving displacement of the release button 11 and a track slot 121. The track slot 121 holds a retaining element 12 which is movable leftwards in the track slot 121 to prohibit the release button 11 from moving. The ceiling dock 10 also contains a digital radio signal transceiver 40 to transmit and receive wireless digital signals.

The loading and unloading structure 30 includes a upper plate 34, a detent member 33, a coupled member 32 and a lower plate 31. The lower plate 31 has an aperture 311 and two sides each have a latch hook 314. The detent member 33 and the coupled member 32 are located between the lower plate 31 and the upper plate 34. The lower plate 31 and the upper plate 34 are fastened together to form an axle hole 312 which is coupled with the axle 15. The detent member 33 has a detent portion 331 running through the aperture 311 and a upper sliding member 332. The coupled member 32 has a side rod 321 driven by the push stem 111 and a lower sliding member 322 located below the upper sliding member 332. The upper plate 34 has a release hole 341 running through by the push stem 111 and corresponding to the side rod 321.

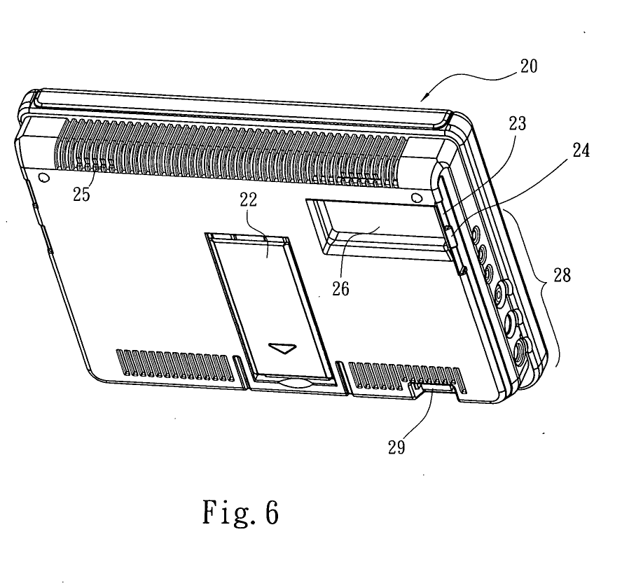

The multimedia player 20 has a LCD screen 27 on a front side, and a bracket 22 and a connector housing trough 26 on a back side. The connector housing trough 26 holds a connector (not shown in the drawings) to be electrically connected a connector 313 of the loading and unloading structure 30. The back side has two edges each has a latch trough 23 and a latch boss 24. The back side further has a detent trough 25 on a top edge and a coupling trough 201 on a bottom edge. The multimedia player 20 further has a disc insertion slot 21 (for optical disks such as CD, VCD and DVD) and a signal transmission port 28 (referring to FIG. 6, for coupling with a USB connector, IEEE 1394 connector, memory card connector, power supply connector, graphic adapter or audio connector or the like). The multimedia player 20 may also include a storage device (such as hard disk, not shown in the drawings).

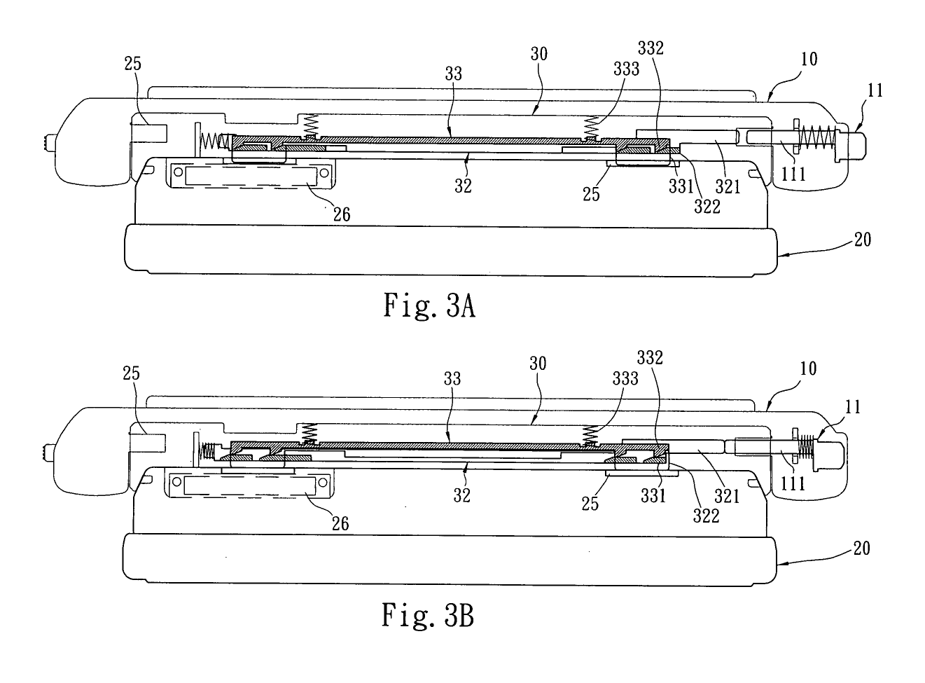

Refer to FIGS. 3A and 3B for the schematic views of the moving relationships of the release button, coupled member and detent member of the present invention. As shown in the drawings, the loading and unloading structure 30 includes a upper plate 34, a detent member 33, a coupled member 32 and a lower plate 31 as previously discussed. The detent member 33 and the coupled member 32 are located between the lower plate 31 and the upper plate 34. The detent member 33 has two sides each has a detent portion 331 and a upper sliding members 332, and a spring 333 above each of two ends thereof. Hence the detent member 33 is in contact with the coupled member 32 in normal conditions. The coupled member 32 has a side rod 321 on one end driven by the push stem 111 and a lower sliding member 322 located below the upper sliding member 332 corresponding to the upper sliding member 332. The upper plate 34 has a release hole 341 running through by the push stem 111 and corresponding to the side rod 321. When the release button 11 is depressed by an external force, the coupled member 32 is driven by the release button 11 and moves leftwards; the lower sliding member 322 pushes the upper sliding member 332 upwards to drive the detent portion 331 upwards to escape from the detent trough 25 of the multimedia player 20; and the multimedia player 20 can be moved forwards. On the contrary, when the external force is absent from the release button 11, the detent member 33 is pushed by spring 333 to return to its original position; the detent portion 331 returns to the detent trough 25 of the multimedia player 20, and the multimedia player 20 cannot be moved forwards.

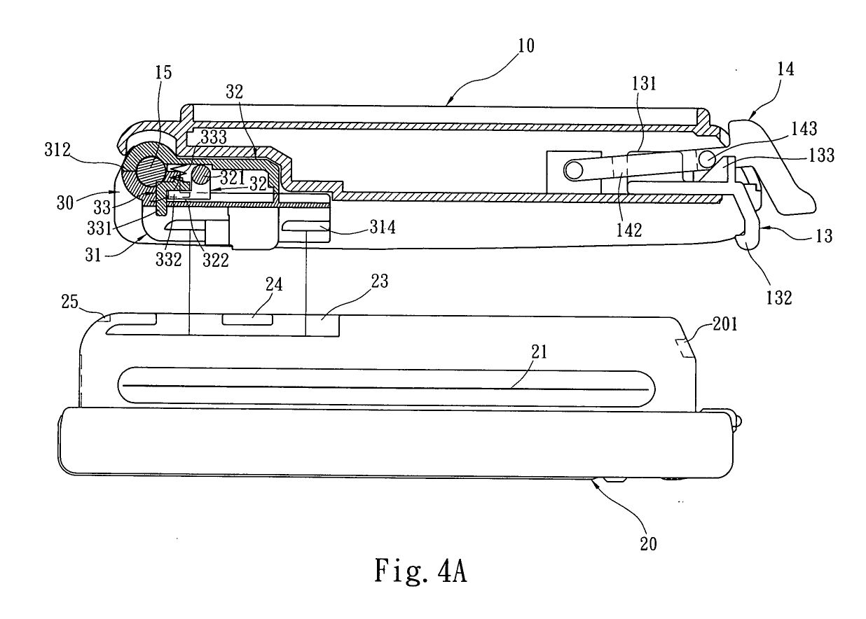

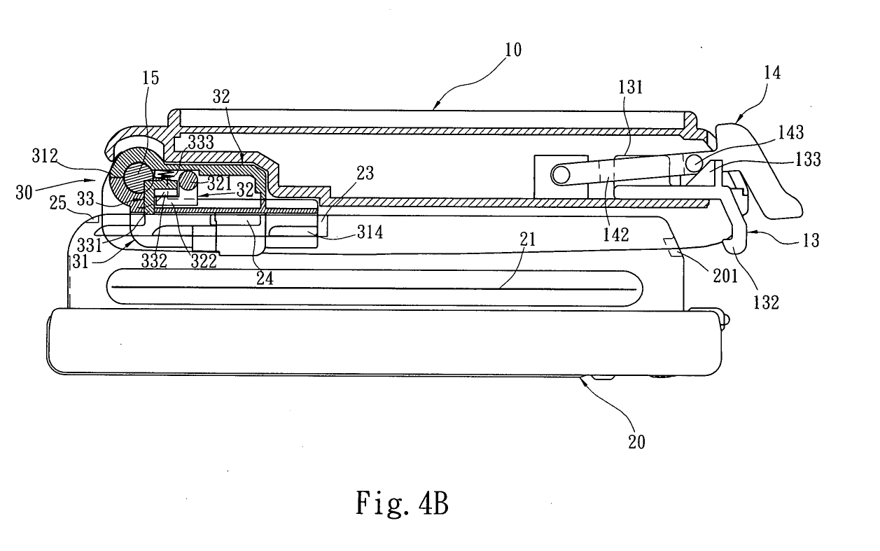

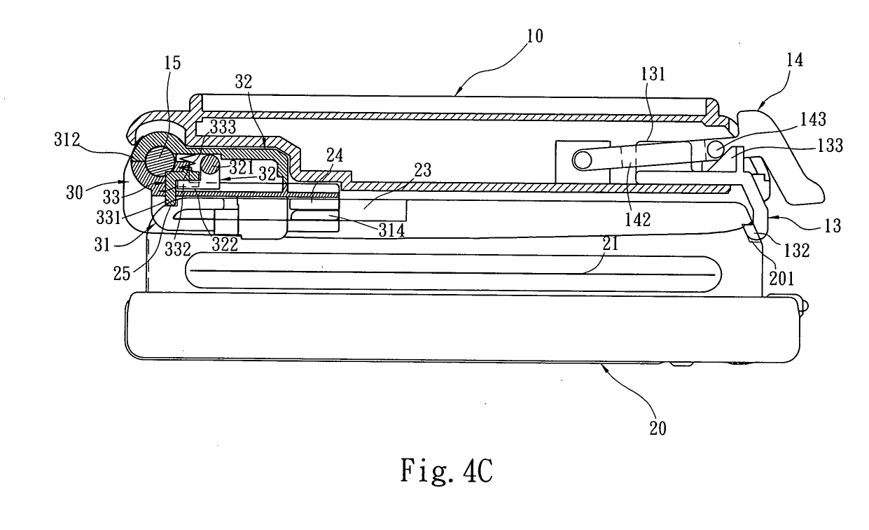

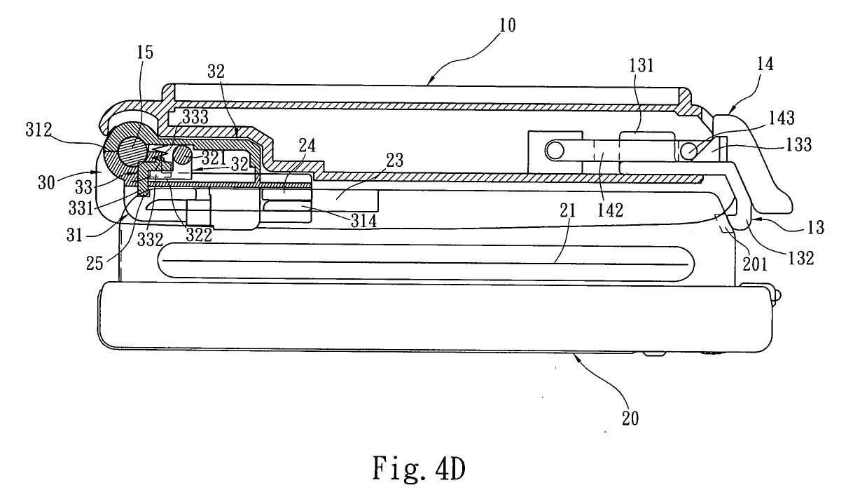

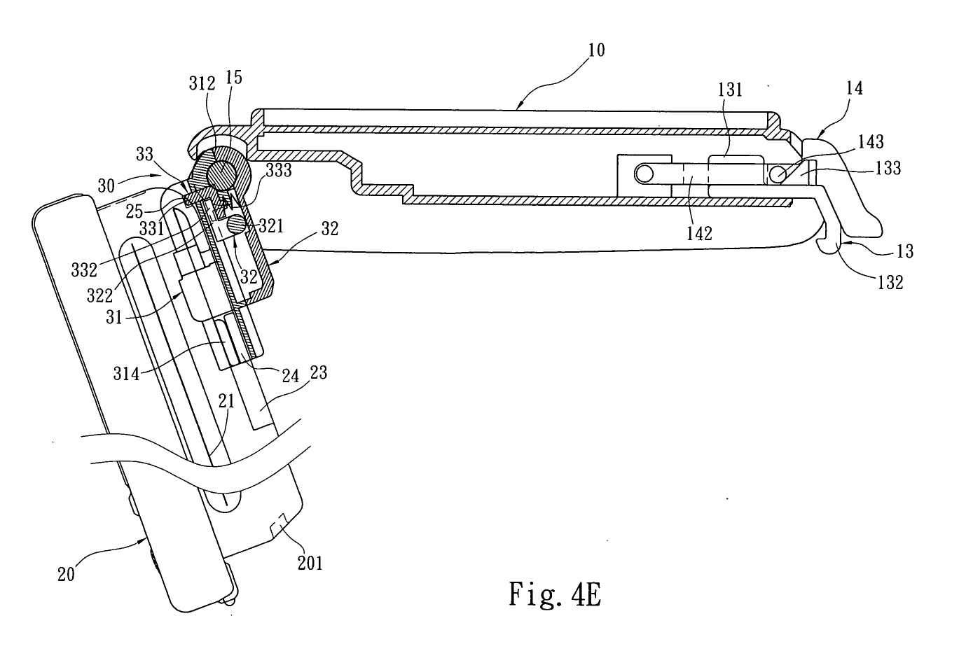

Refer to FIGS. 4A through 4E for the schematic views of loading operations for the multimedia player of the present invention. To install the multimedia player 20 on the ceiling dock 10, first, align the latch trough 23 of the multimedia player 20 with the latch hook 314 of the lower plate 31, and wedge the latch hook 314 in the latch trough 23 to form a coupling between them; meanwhile the detent member 33 is pushed upwards by the multimedia player 20; next, move the multimedia player 20 rearwards until the latch hook 314 is latched on the latch boss 24; the detent portion 331 is wedging in the detent trough 25 of the multimedia player 20 due to the corresponding relationship; as the coupling trough 201 of the multimedia player 20 is corresponding to the coupling member 13 of the ceiling dock 10, the coupling end 132 is latched in the coupling trough 201; hence the multimedia player 20 can be installed rapidly in the holding space 17 of the ceiling dock 10 and anchored. When the hand-push member 14 is moved downwards by an external force, due to its one end is fastened to the ceiling dock 10, the ramming end 143 on another end is moved downwards to push the inclined lump 133 of the coupling member 13; the coupling member 13 compresses the spring 161; hence the coupling end 132 is moved to release the coupling trough 201; therefore the multimedia player 20 can be rotated about the axle 15 to a desired viewing angle for users.

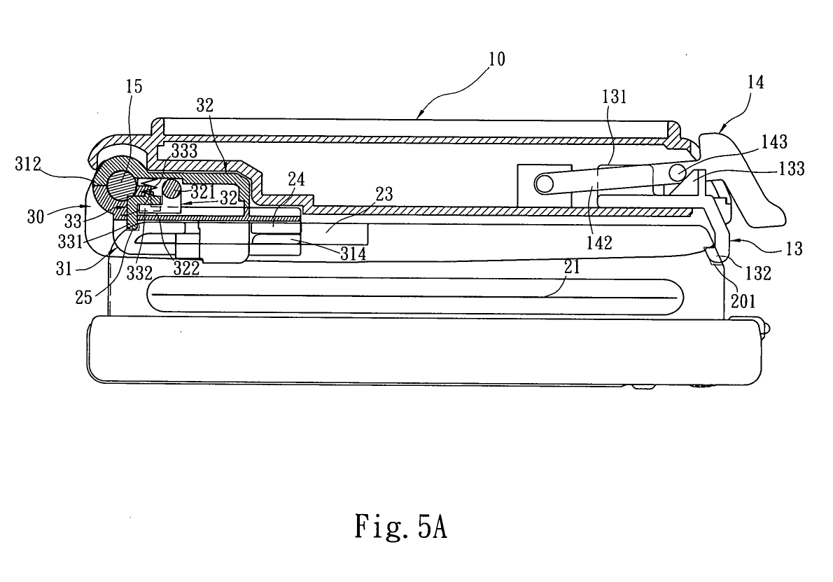

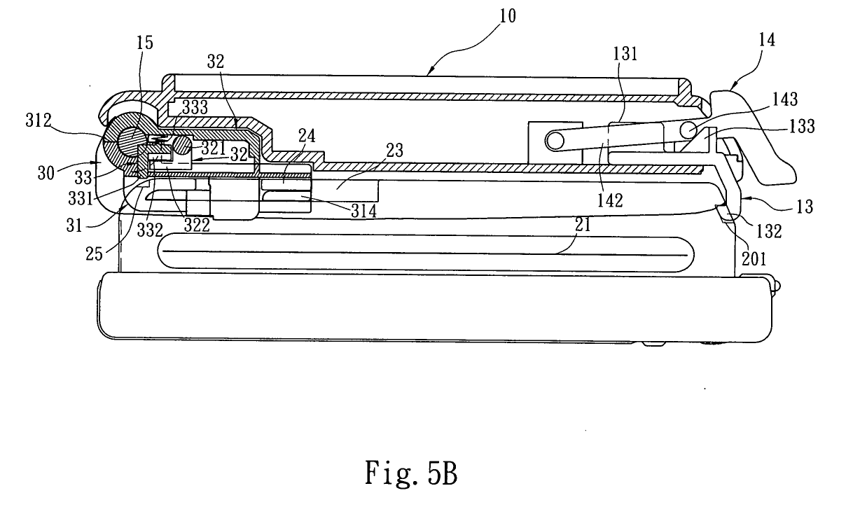

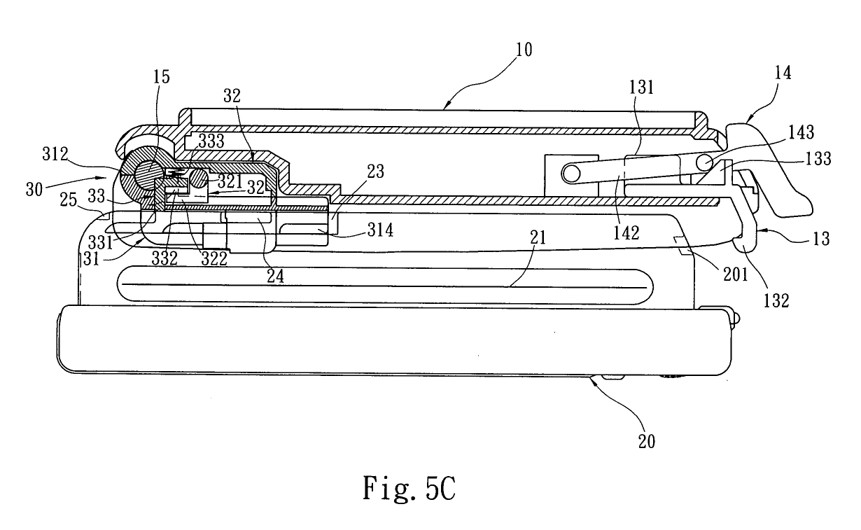

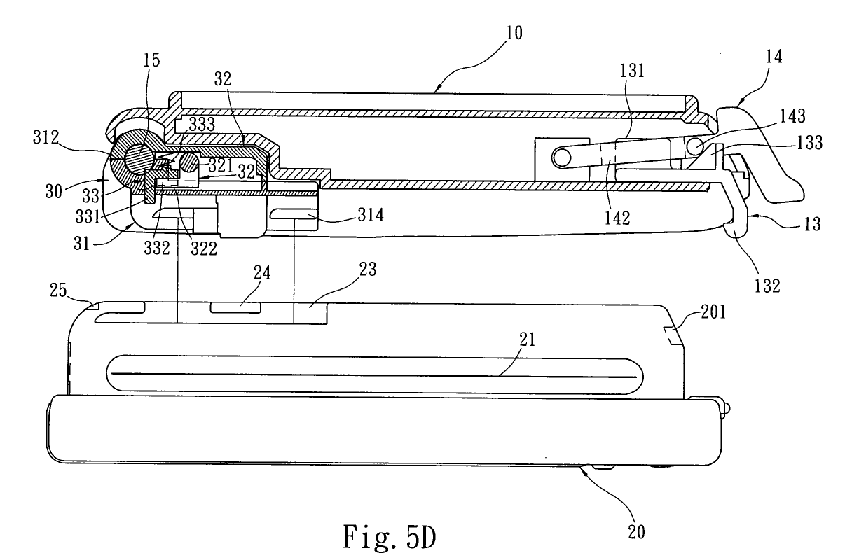

Refer FIGS. 5A through 5D, and 6 for the schematic views of unloading operations for the multimedia player of the present invention. To remove the multimedia player 20, first, as shown in FIGS. 3A and 3B, depress the release button 11; the coupled member 32 is driven leftwards to push the detent portion 331 upwards to escape from the detent trough 25 of the multimedia player 20; the multimedia player 20 can be moved forwards to slide the latch hook 314 out of the latch trough 23; then it can be separated from the loading and unloading structure 30, and the multimedia player 20 can be removed from the holding space 17 of the ceiling dock 10.

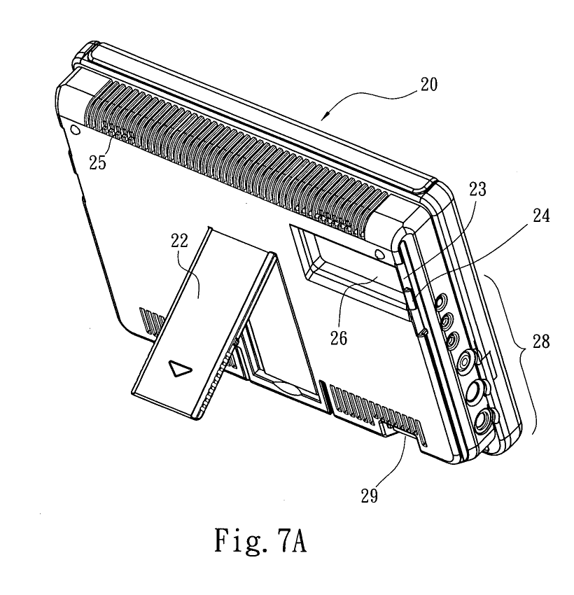

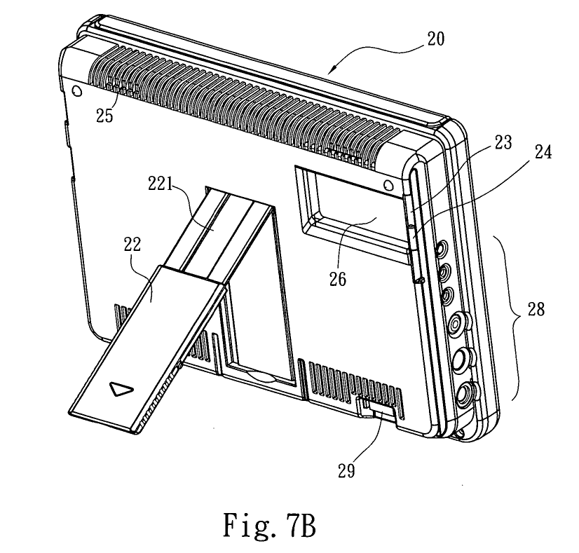

Refer to FIGS. 7A and 7B for the schematic views of the multimedia player of the present invention after unloaded and braced by the bracket. The bracket 22 on the back side of the multimedia player 20 has one end hinged on the multimedia player 20. When another end of the bracket is moved outwards, the bracket 22 and the multimedia player 20 form an included angle to brace the multimedia player 20. The bracket 22 further has a sliding track 221. When users want to adjust the viewing angle, pulling the bracket 22 downwards, the bracket 22 can slide along the sliding track 221 to extend the bracing length.

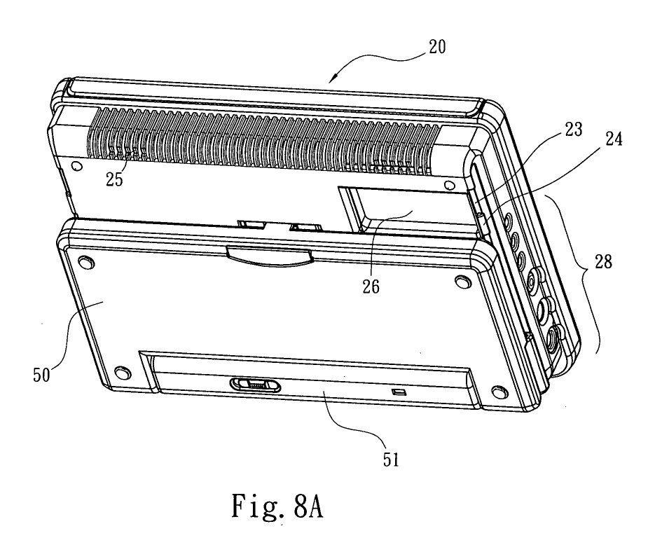

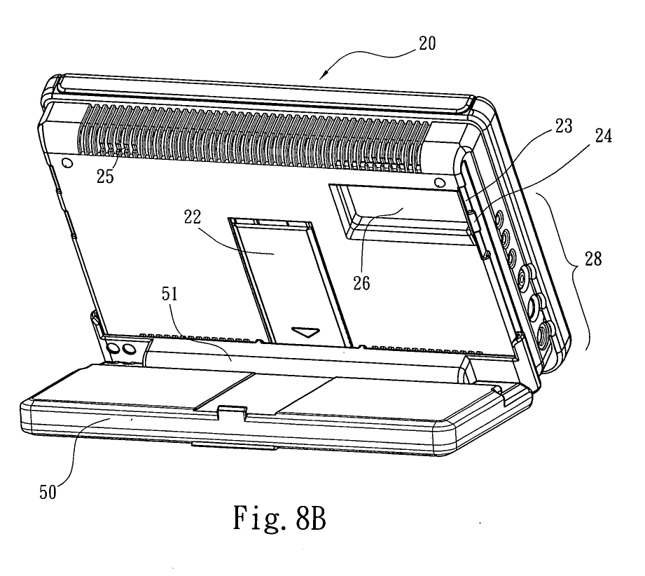

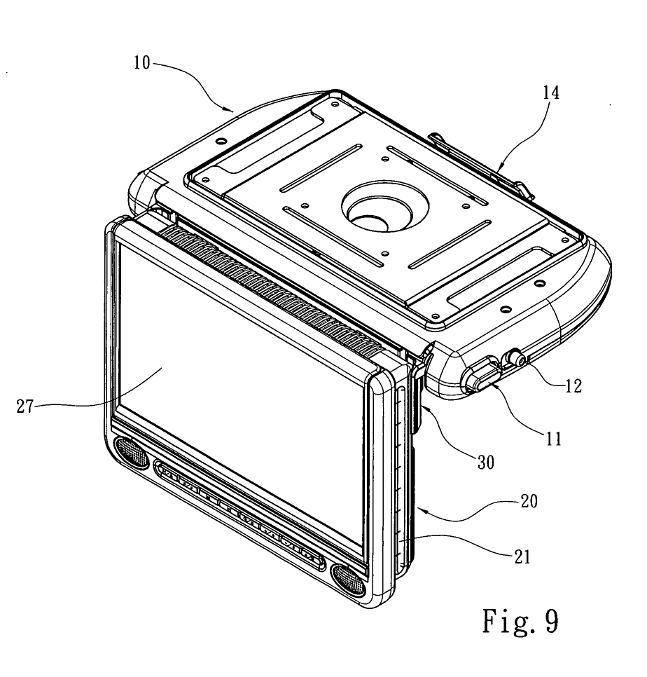

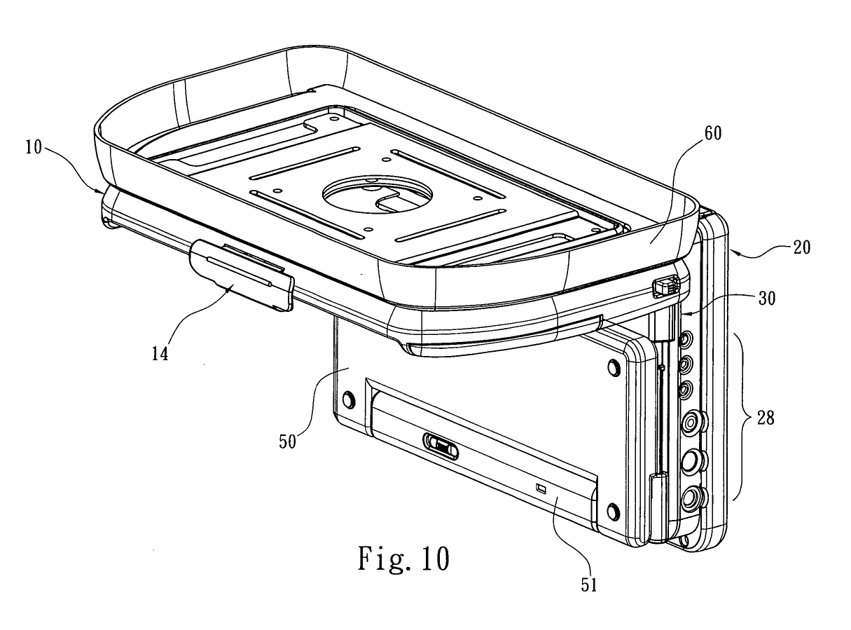

Refer to FIGS. 8A and 8B for the schematic views of the multimedia player of the present invention after removed for loading batteries. The multimedia player 20 has a battery connector 29 on the back side. A battery 50 equipped with a shaft 51 may be designed and loaded for use. After the battery 50 is loaded, it not only supplies electric power for the multimedia player 20, the shaft 51 can also bear the weight of the multimedia player 20 to adjust the viewing angle. Refer to FIGS. 9 and 10 for the multimedia player of the present invention attached to the ceiling dock and adorned with an ornamental board. After the multimedia player 20 is loaded with the battery 50 and installed on the ceiling dock 10, the battery 50 can be charged. As shown in FIG. 10, the juncture of the ceiling dock 10 and the vehicle top inner side (not shown in the drawings) can be bonded with an ornamental board 60 to enhance aesthetic appealing.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A portable vehicle top multimedia player, comprising:
a ceiling dock fastened to an inner side of a vehicle top including a release button, an axle, a coupling member and a holding space; the release button having a push stem, the coupling member having a coupling end;
a loading and unloading structure including a upper plate, a detent member, a coupled member and a lower plate; the lower plate having an aperture and two sides each having a latch hook, the detent member and the coupled member being located between the lower plate and the upper plate, the lower plate and the upper plate being fastened together to form an axle hole which is pivotally coupled with the axle; the detent member having a detent portion running through the aperture and a upper sliding member; the coupled member having a side rod driven by the push stem and a lower sliding member located below the upper sliding member corresponding therewith; the coupled member being driven leftwards and rightwards by the release button, and the upper sliding member being pushed upwards and downwards by the lower sliding member to move the detent portion up and down; and
a multimedia player having a back side which has two edges each having a latch trough and a latch boss, and a detent trough on a top edge and a coupling trough on a bottom edge thereof;
wherein the multimedia player is loadable in the holding space for anchoring or unloadable for removing rapidly by latching the latch hook on the latch boss through the latch trough, running the detent portion through the aperture to press the detent trough and latching the coupling end in the coupling trough.

2. The portable vehicle top multimedia player of claim 1, wherein the ceiling dock has a housing trough to hold a spring, the coupling member having a jutting trough and an inclined lump, the jutting trough covering the housing trough and having one end in contact with the spring, the ceiling dock also having a hand-push member which has an opening running through by the jutting trough and a ramming end pressing the inclined lump; the hand-push member having one end hinged on the ceiling dock so that the ramming end is movable downwards to press the inclined lump and compress the spring, thereby the coupling end is moved to escape from the coupling trough.

3. The portable vehicle top multimedia player of claim 1, wherein the ceiling dock has a cavity to confine the moving displacement of the release button.

4. The portable vehicle top multimedia player of claim 1, wherein the ceiling dock has a track slot to hold a retaining element which is movable leftwards in the track slot to prevent the release button from moving.

5. The portable vehicle top multimedia player of claim 1, wherein the upper plate has a release hole running through by the release button to correspond to the side rod.

6. The portable vehicle top multimedia player of claim 1, wherein the ceiling dock contains a digital radio signal transceiver.

7. The portable vehicle top multimedia player of claim 1, wherein the ceiling dock has an ornamental board.

8. The portable vehicle top multimedia player of claim 1, wherein the multimedia player is a liquid crystal screen.

9. The portable vehicle top multimedia player of claim 1, wherein the multimedia player has a disc insertion slot for receiving an optical disk which is selected from the group consisting of a CD, a VCD and a DVD.

10. The portable vehicle top multimedia player of claim 1, wherein the multimedia player has a hard disk storage device.

11. The portable vehicle top multimedia player of claim 1, wherein the multimedia player has a signal transmission port on one side for coupling with a USB connector, an IEEE 1394 connector, a memory card connector, a power supply connector, a graphic adapter or an audio connector.

12. The portable vehicle top multimedia player of claim 1, wherein the multimedia player has a bracket which contains a sliding track.

13. The portable vehicle top multimedia player of claim 12, wherein the multimedia player has a battery connector to electrically connect to a battery.
